(19) United States
(12) Patent Application Publication
(10) Pub. No.: US 2010/0289177 A1
(43) Pub. Date: Nov. 18, 2010

(54) Method for the production of shaped cellulose bodies

(76) Inventors: Sigrid Redlinger, Lenzing (AT); Gerhard Reiter, Seewalchen (AT); Heinrich Firgo, Vöcklabruck (AT)

Correspondence Address: BAKER BOTTS L.L.P., 30 ROCKEFELLER PLAZA, 44TH FLOOR, NEW YORK, NY, 10112-4498, US

(21) Appl. No.: 12/818,020

(22) Filed: Jun. 17, 2010

Related U.S. Application Data
(63) Continuation of application No. 11/033,437, filed on Jan. 11, 2005, now abandoned.
Application No. 11/033,437 is a continuation of application No. PCT/AT03/00186, filed on Jul. 4, 2003.

(30) Foreign Application Priority Data
Jul. 12, 2002 (AT) 1051/2002

(51) Int. Cl. B29C 71/00

(52) U.S. Cl. 264/233

(57) ABSTRACT

The present invention relates to a process for the production of cellulosic moulded bodies according to the amine-oxide process, comprising the following steps:
moulding a solution of cellulose in an aqueous tertiary amine oxide
precipitating the moulded solution
washing the moulded body thus obtained and
drying the moulded body.

The process according to the invention is characterized in that a chitosonium polymer is added to the solution of the cellulose and/or to a precursor of said solution and/or the moulded body is treated with a chitosonium polymer prior to drying, with the chitosonium polymer being essentially completely soluble in a standard dope.

### CROSS REFERENCE TO RELATED APPLICATION(S)

The present application is a continuation of U.S. Ser. No. 11/033,437, filed Jan. 11, 2005, which is a continuation of International Patent Application No. PCT/AT03/00186, filed Jul. 4, 2003, published in German on Jan. 22, 2004 as International Patent Publication No. WO04/007818, which claims priority to Austrian Application No. A 1051/2002, filed Jul. 12, 2002, each of which are incorporated by reference herein in their entireties for all purposes.

### BACKGROUND OF THE INVENTION

The invention relates to a process for the production of cellulosic moulded bodies according to the amine-oxide process.

As an alternative to the viscose process, in recent years there have been described a number of processes wherein cellulose, without forming a derivative, is dissolved in an organic solvent, a combination of an organic solvent and an inorganic salt, or in an aqueous saline solution.

So far, however, only one process for the production of such moulded bodies has achieved industrial-scale realisation. In this process, a tertiary amine oxide, particularly N-methylmorpholine-N-oxide (NMMO), is used as a solvent. The process for the production of moulded bodies from a solution of cellulose in an aqueous tertiary amine oxide is referred to as the “amine-oxide process” or “Lyocell process”.

In said process, the solution of the cellulose usually is extruded by means of a forming tool, whereby it is moulded. Via an air gap, the moulded solution gets into a precipitation bath, where the moulded body is obtained by precipitating the solution. The moulded body is washed and optionally is dried after further treatment steps.

Cellulose fibres produced from such solutions are called “solvent-spun” fibres and have received by BISFA (The International Bureau for the Standardisation of man made Fibres) the generic name Lyocell. A process for the production of Lyocell fibres is described, for instance, in U.S. Pat. No. 4,246,221. The amine-oxide process yields fibres which are distinguished by a high tensile strength, a high wet-modulus and a high loop strength.

Chitin and chitosan are natural, biodegradable, non-toxic, non-allergenic, bioactive and biocompatible polymers with a structure similar to that of cellulose. Chitin is gained from the shells of crustaceans, a waste material of the crab and shrimp industries. The worldwide interest in the range of use for chitin has seen an enormous increase in recent years as it is regarded as the second largest resource of natural polysaccharides beside cellulose.

Chitosan consists of poly-(1,4)-2-amino-2-desoxy-beta-D-glucose and is produced by deacetylation of chitin (poly-(1,4)-2-acetamide-2-desoxy-beta-D-glucose). For reasons of solubility—chitin is insoluble in water, organic solvents, diluted acids and bases—chitosan, which is soluble in diluted acids, aqueous methanol and glycerol, has the by far greater significance.

Areas of application for chitin and chitosan are the immobilisation of cells and enzymes in biotechnology, the treatment of wounds in medicine, the use as nutritional supplement and preserving agent in the food industry, the preservation of seeds in agriculture, the use as flocculating agent and chelating agent with heavy metals in sewage systems.

However, a modification of the chitin/chitosan has to be carried out for most areas of application in order to improve the solubility in aqueous systems.

The use of chitosan in the textile industry is divided into three fields of application:

the production of 100% chitosan fibres and the production of “man-made fibres” with incorporated chitosan, respectively

the finishing and coating of textile fibres

auxiliary process agents for the textile industry

Due to their antibacterial properties and inhibitory effects on the growth of pathogenic germs, chitosan fibres are used in the field of medicine, as wound coverage and surgical sutures. Chitin and chitosan, respectively, can be broken down enzymatically or hydrolytically by endogenic ferments and therefore are reabsorbable fibres. The effect of such natural polymers on the healing of wounds consists in the gradual release of N-acetyl-glucosamine, the mucopolysaccharide organisation of the collagen as well as the beneficial effect on the tissue growth during wound healing.

The disadvantage of fibres made of 100% chitosan, however, consists in that they exhibit low dry strength (chitosan fibres of Messrs. Innovative Technology Ltd., Winsford, England: titer 0.25 tex; fibre strength conditioned 9 cN/tex; fibre elongation conditioned 12.4%; chitosan fibres of Messrs. Korea Chitosan Co. LTD: fibre strength conditioned 15 cN/tex; fibre elongation conditioned 26%), that they are extremely brittle and that the wet strength amounts to merely 30% of the dry strength. Therefore, either chitosan fibres are admixed to other man-made fibres, or chitosan is already added to the spinning mass during the manufacturing process of, f.i., viscose fibres.

Viscose fibres with incorporated chitin/chitosan (in the following: “chitosan-incorporated viscose fibres”) are commercially available, f.i., under the trade names Crabyon (Messrs. Omikenshi Co) and Chitopoly (Messrs. Fuji Spinning Co.). Those fibres are produced, for instance, by dispersing chitosan or acetylated chitosan in powder form with a grain size of below 10μ in water in an amount of from 0.5 to 2% by weight and by adding it to the viscose dope (U.S. Pat. No. 5,320,903). Thereupon, fibres are produced in accordance with the conventional viscose process or even the polynosic process.

Further manufacturing processes for chitosan-incorporated viscose fibres are described in U.S. Pat. No. 5,756,111 (complex pre- and after-dissolution processes at low temperature in order to obtain alkaline chitin-chitosan solutions to be added to the viscose solution) and in U.S. Pat. No. 5,622,666 (addition of microcrystalline chitosan and a water- and/or alkali-soluble natural polymer, fi., sodium alginate, which can form ionic bonds with the chitosan, as a dispersion to the viscose dope).

The chitosan-incorporated viscose fibres exhibit an increased dye affinity, an increased water retention value, fungicidal and odour-reducing properties, but also the low wet strength viscose fibres are known for. Since chitosan prevents the growth of bacteria harmful to the skin and eliminates allergic effects, for instance, fabrics made of Chitopoly are particularly suitable for dermatitis patients.

The drawback of all the methods described consists in that the fibres thus obtained contain very fine chitosan particles, since the chitosan is not soluble in the spinning mass.

The secondary agglomeration of the chitosan in the spinning mass or the inhomogeneous distribution, respectively, results in a deterioration of the spinning properties, spinning of fibres with low titres is extremely difficult. For that reason, it is also impossible to increase the amount of incorporated chitosan, since, in doing so, there would be an immediate loss of textile data or, already during spinning, numerous fibre breakages would occur. Furthermore, leakages of chitosan occur in the spinning bath, since chitosan is soluble in acids. For the incorporation of chitosan, additional complex steps are necessary.

Subsequently, it also was attempted to incorporate chitosan in solvent-spun cellulose fibres produced in accordance with the amine-oxide process, in particular because of the high wet and dry strength of Lyocell fibres.

In DE 195 44 097, a process for the production of moulded bodies from polysaccharide mixtures is described, wherein cellulose and a second polysaccharide are dissolved in an organic polysaccharide solvent mixable with water (preferably NMMO), which may also contain a second solvent.

In order to create a solution, cellulose and/or at least one water-insoluble cellulose derivative and, as a second polysaccharide, at least one polysaccharide that is distinguished therefrom by its increased solubility in water are used. As the third polysaccharide, chitin, chitosan, an N- or O-hydroxy-alkylated or carboxy-alkylated chitin or chitosan derivative may be used. In the Examples, the production of two chitosan-incorporated cellulose fibres is described, wherein, in each case, a second solvent is used in addition to NMMO and a carboxy-methylated chitosan is added. The use of the fibre as an agent for the formation of water and heavy metals for moulded bodies with bactericidal and fungicidal properties is claimed.

Furthermore, in KR-A 9614022, the production of chitin-cellulose fibres, referred to as “chitulose”, is described, wherein chitin and cellulose are dissolved in a solvent from the group comprising dimethylimidazoline/LiCl, dichloroacetate/chlorinated hydrocarbon, dimethylacetamide/LiCl, N-methylpyrrolidone/LiCl, and yarns are produced according to the wet spinning process. NMMO is not mentioned in the claims.

In EP-A 0 883 645, among other things, the addition of chitosan to the solution as a modified compound for increasing the elasticity of wraps for foodstuff is claimed. The modifying compounds must be miscible with the cellulose/NMMO/water solution.

In DE-A 100 07 794, the production of polymer compositions is described, comprising a biodegradable polymer and a material consisting of sea weeds and/or the shells of sea animals, as well as the production of moulded bodies therefrom. The addition of a material made of sea weeds, sea animals in powder form, in the form of a powder suspension or in liquid form to the cellulose solution produced according to the Lyocell process is also claimed. Furthermore, the material may also be added after or during the shredding of the dry cellulose as well as at any stage of the manufacturing process. Despite the addition of the additive, the fibres exhibit the same textile-mechanical properties as they would without the additive. In the Examples, only Lyocell fibres that have a brown algae powder incorporated are described, wherein, for the production of the spinning mass, the brown algae dust, NMMO and pulp and a stabilizer are mixed and heated to 94° C.

Furthermore, in the final report “Erzeugnisse aus Polysaccharidverbunden” (Taeger, E.; Kramer, H.; Meister, F.; Vorwerg, W.; Radosta, S; TITK-Thüringisches Institut für Textil-und Kunststoff-Forschung, 1997, pp. 1-47, report no. FKZ 95/NR 036 F) it is described that chitosan is dissolved in diluted organic or inorganic acids and then is precipitated in an aqueous NMMO solution. Thus, a suspension of fine chitosan crystals is obtained in the cellulose solution, which then is spun. According to said document, the chitosan remains in the solution in the form of fine crystals even after the dissolution of the cellulose. That leads to the formation of a microheterogeneous two-phase system in the fibre. The strength of the fibre is low (with 10% chitosan: fibre strength conditioned 19.4 cN/tex; fibre elongation conditioned 11.5%).

Conventional standard chitosan grades that are commercially available are insoluble in the water/NMMO/cellulose solution, and, in accordance with the described methods, spinning masses are obtained wherein the chitosan particles are provided in the cellulose solution as a second phase. Furthermore, very fine chitosan particles swell in the spinning medium, which leads to spinning problems/cloggings of the die.

### SUMMARY OF THE INVENTION

The present invention relates to a process for producing shaped cellulose bodies according to the amine oxide process comprising the following steps: a cellulose solution is shaped in an aqueous tertiary amine oxide; the shaped solution is precipitated; and the obtained shaped body is washed and dried. The process is characterized by the fact that a chitosonium polymer is added to the cellulose solution and/or a precursor of said solution, and/or the shaped body is treated with a chitosonium polymer before being dried, said chitosonium polymer being essentially entirely soluble in a standard spinning solution. The present invention also relates to cellulosic molded bodies made according to the process of the present invention.

### BRIEF DESCRIPTION OF THE FIGURES

FIG. 1 shows a photograph of a standard dope which does not contain any additive.

FIG. 2 shows a photograph of a standard dope containing 5% by weight (based on pulp) of chitosonium polymer as described in Example 5.

FIG. 3 shows a photograph of a standard dope containing 10% by weight (based on pulp) of chitosonium polymer as described in Example 1.

FIG. 4 shows a photograph of a standard dope containing 200% by weight (based on pulp) of chitosonium polymer as of an undissolved additive.

FIG. 5 shows a microphotograph of spinning mass 6 described in Example 2.1.

FIG. 6 shows a microphotograph of spinning mass 8 described in Example 3.

### DETAILED DESCRIPTION OF THE INVENTION

The present invention has as its object to provide a process for the production of a Lyocell fibre which incorporates chitosan or a chitosan salt in the cellulose matrix and/or exhibits the same at the surface of the fibre and wherein the drawbacks of the prior art as described are avoided. A further aspect of the present invention relates to such Lyocell fibres.

The object of the present invention is achieved by means of a process for the production of cellulosic moulded bodies according to the amine-oxide process, comprising the following steps:

moulding a solution of cellulose in an aqueous tertiary amine oxide

precipitating the moulded solution

washing the moulded body thus obtained and

drying the moulded body,

which is characterized in that a chitosonium polymer is added to the solution of the cellulose and/or to a precursor of said solution and/or the moulded body is treated with a chitosonium polymer prior to drying, with the chitosonium polymer being essentially completely soluble in a standard dope.

In the literature, there is no uniform definition for the demarcation between chitin and chitosan.

For the purpose of the present invention, the term “chitin” is meant to indicate a β-1,4-bound polymer of 2-acetamido-2-desoxy-D-glucose having a degree of deacetylation of 0%. Also for the purpose of the present invention, the term “chitosan” indicates an at least partially deacetylated β-1,4-bound polymer of 2-acetamido-2-desoxy-D-glucose.

The term “chitosonium polymer” indicates a salt of chitosan comprising an inorganic and/or organic acid.

For the purpose of the present invention, the term “polymer” also comprises low-molecular oligomers of the deacetylated 2-acetamido-2-desoxy-D-glucose or the salts thereof, respectively, beginning with an average degree of polymerisation of 2.

As “precursors” of the cellulose solution, starting and intermediate products, respectively, of the production of the cellulose solution, such as the pulp that is used, the tertiary amine oxide or a suspension of the cellulose in the aqueous tertiary amine oxide, are meant.

The N-methylmorpholine-N-oxide is meant by “NMMO”. As a standard dope, a dope of the composition 13% by weight of pulp, 77% by weight of NMMO, 10% by weight of water and 0.1% by weight (based on the total solution) of a conventional stabilizer, which is produced in accordance with the process described in the example part, is meant.

The term “essentially completely soluble” is meant to indicate that, at a content of up to 10% by weight of chitosonium polymer, based on pulp, essentially no undissolved particles of the chitosonium polymer are visible in the standard dope during the microscopic evaluation described in the example part. For the purpose of the present invention, gel-like particles of the chitosonium polymer are regarded as dissolved particles.

Surprisingly, it has been shown that certain chitosonium polymers are soluble in the solution of cellulose in the tertiary amine oxide. If such chitosonium polymers are added to the cellulose solution or to a precursor thereof, they are provided in the NMMO/water/cellulose solution in a uniform homogeneous distribution which, under the microscope, is no longer differentiable from the cellulose matrix.

It is known that chitosan forms water-soluble chitosonium salts—which, in the literature, are also referred to as chitosonium polymers—with many organic and inorganic acids, which chitosonium salts are isolated in powder form, f.i., by freeze drying or spray drying. The preparation and use of said chitosonium polymers is known in literature and is described in numerous patents. Furthermore, chitosonium polymers are commercially available.

It has been shown that, as chitosonium polymers, in particular those having a degree of deacetylation of from 10 to 100%, preferably from 50 to 90%, and a molecular weight of from 1 to 10000 kDa, preferably from 1 to 1500 kDa, are suitable.

From “Dry Chitosan Salts and Complexes of Aliphatic Carboxylic Acids”, P. R. Austin and S. Sennett, Chitin in Nature and Technology, edited by R. Muzzarelli, C. Jeuniaux; G. W. Gooday, Plenum Press New York, pp. 279-286, it is known that chitosonium polymers can furthermore exist in a form in which an excess amount of acid is provided as a solvate or complex. It has been found that chitosonium polymers having a salt content of more than 0.4, preferably from 0.5 to 2.5, exhibit good solubility in NMMO and hence are particularly suitable for the process according to the invention. Thereby, the salt content is defined as the ratio of mole of acid per mole of chitosan.

The production of chitosonium polymers is furthermore described, for instance, in U.S. Pat. No. 4,929,722, U.S. Pat. No. 4,946,870 as well as U.S. Pat. No. 5,900,479.

Commercially available chitosonium polymers, fi. chitosan acetates, chitosan chlorides, chitosan citrate or chitosan lactate, are preferably used. Chitosonium polymers are skin-compatible, promotive to wound healing and mildly antibacterial. The use of a chitosan chloride is particularly preferable.

If sprayed onto burns, chitosan acetate solutions generate a wound-healing protective film (U.S. Pat. No. 4,929,722).

The use of chitosonium polymers as agents for fibre treatment is described in U.S. Pat. No. 5,900,479, WO 00/49219 and WO 01/34897.

Therein, the chitosonium polymer is rendered water-insoluble by increasing the pH-value to at least pH>5.5, preferably pH≧6.6, i.e., the cationically charged chitosonium salt is retransformed into the respective chitosan/chitin (WO 92/09636). A further method of transforming the chitosonium polymer into the N-acyl-glucose-amine polymer consists in a mild heat treatment (100-130° C.) such as described in U.S. Pat. No. 5,900,479.

Preferably, the chitosonium polymer is added to the cellulose solution at a concentration of from 1% by weight to 50% by weight, preferably from 1% by weight to 10% by weight, based on cellulose. The chitosonium polymer may be added in solid form, for instance as a powder, or in the form of a solution or suspension.

Microphotographs (transmitted light-Microscope Olympus BH-2, photograph with polarizing filter at 100- and 400-fold magnification) of the cellulose solution produced by means of a chitosonium polymer show that the chitosonium polymer is provided in a uniform homogeneous distribution which no longer is differentiable from the cellulose matrix.

From the solution, moulded bodies such as Lyocell fibres are produced in a manner known per se.

In a further preferred embodiment of the process according to the invention, the moulded body (f.i. the fibres) obtained from the cellulose solution is treated with a solution or suspension of the chitosonium polymer prior to drying. In case of Lyocell fibres, they are referred to as never-dried fibres in that context.

The chitosonium polymer is contained in the treatment solution or suspension preferably in an amount of from 0.1% by weight to 10% by weight, preferably from 0.5% by weight to 3% by weight.

The pH of the spinning bath of ≧7, which is common for the production of moulded bodies according to the amine-oxide process, and the subsequent drying of the moulded bodies indeed suffice for retransforming the chitosonium polymer contained in the moulded body or applied onto the moulded body, respectively, into the respective chitosan.

However, in order to make sure that all cationically charged groups will again be provided as amine groups, an alkali treatment, preferably by means of 20 g/l of soda, followed by neutral washing, may be applied to the moulded body incorporating the chitosonium polymer or the chitosan, respectively, already regenerated therefrom partially or completely and/or containing the same at the surface. Said treatment is preferably applied to the never-dried moulded body during its manufacture but may also be applied afterwards to the dried moulded body.

For said purpose, furthermore a treatment with superheated steam may be carried out instead of or in addition to the alkali treatment.

For the continuous treatment of never-dried Lyocell fibres, preferably the cut fibres, which were washed until they were free from NMMO and which exhibit a defined humidity of from 50% to 500% adjusted, for instance, by squeezing, are contacted with a batch containing the chitosonium polymer dissolved in water, in a loose assembly (“fleece”) on a moving screen belt, and are soaked, for instance, by spraying (“impregnation”). Following the impregnation, the fleece is squeezed to a defined humidity of 50%-500%, and the squeezed treatment batch is returned to the impregnation cycle. Thereupon, the fleece is contacted with alkali (for example, by spraying) in order to fix the chitosonium polymer and/or is treated with superheated steam and subsequently is washed neutrally.

In a further preferred embodiment, the moulded body is subjected to a treatment with a cross-linking agent prior to or after drying. In case the moulded body was treated with a solution or suspension of the chitosonium polymer, it is advantageous to carry out the treatment with the cross-linking agent after the treatment with the chitosonium polymer.

When treating the fibre with a cross-linking agent in an alkaline environment, an additional alkali treatment of the fibre may be omitted. Furthermore, it is advantageous to carry out a treatment with superheated steam after both treatments, i.e., both after the treatment with the solution or suspension of the chitosonium polymer and after the treatment with the cross-linking agent.

Suitable cross-linking agents are described, for instance, in WO 99/19555.

The present invention also relates to a solution of cellulose in a tertiary amine oxide, containing a chitosonium polymer, which is essentially completely soluble in a standard dope.

From solutions according to the invention, moulded bodies can be produced in a manner known per se, which—as explained above—contain the chitosonium polymer or the chitosan, respectively, and exhibit excellent properties.

Accordingly, the present invention also relates to moulded bodies obtainable by the process according to the invention, in particular in the form of fibres.

In contrast to the prior art (see in particular final report FKZ 95 NR 036 F), fibres according to the invention exhibit excellent textile properties despite a chitosan content of up to 10% by weight. The fibres exhibit an excellent spinning behaviour—it also is possible to produce fibres with low titres—as well as both in the dry and in the wet states the good fibre—mechanical properties that are typical of Lyocell; and, already without finishing, they exhibit high suppleness (soft hand).

Furthermore, the fibres exhibit an increased water retention value, an increased moisture absorption, an increased colourability as well as mildly antimicrobial and wound-healing haemostatic properties.

### EXAMPLES

### Preparation of a Standard Dope

The standard dope is produced from a suspension containing pulp, a stabilizer, NMMO (aqueous 60% solution) as well as the respective additive (chitosonium polymer) in a manner known per se.

The solutions are produced in a kneader HKD-T 0,6 of Messrs. IKA Labortechnik, whereby the solution is obtained in the desired composition as described above by evaporating the excess amount of water in vacuo within a dissolution period of 60-70 minutes and at a solution temperature of 100-110° C. from said mixture of pulp/water/NMMO/stabilizer as well as the additive.

At first, the mixture of NMMO, water, pulp, a stabilizer and the additive is kneaded in the kneader for one hour at room temperature and at an absolute pressure of 250 mbar (impregnation).

Thereafter, the thermostat temperature is adjusted to 130° C. 5 minutes after reaching a temperature of the mixture of 70° C., the absolute pressure is decreased by 25 mbar every further 5 minutes until 50 mbar has been reached. After approximately 60-70 minutes at a temperature of the mixture of 100-110° C., the amount of water corresponding to the composition of the solution will have been removed by distillation, the vacuum is removed and the quality of the solution is assessed.

Microscopic Assessment of the Standard Dope

The assessment of the quality of the solution is carried out by means of a microscope of Messrs. Olympus, type BH-2, by using a polarizing filter at 100-fold magnification.

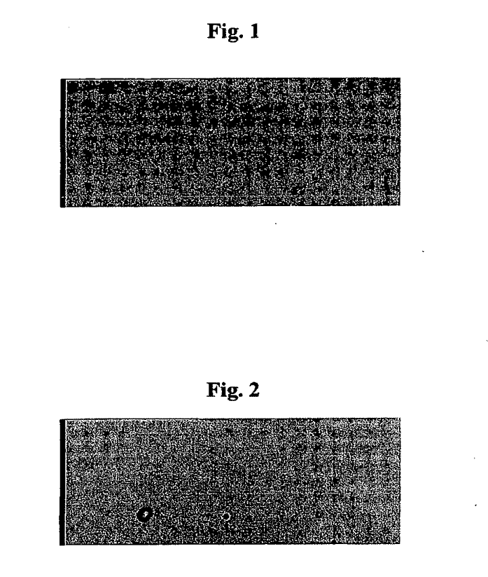

FIG. 1 shows the photograph of a standard dope which does not contain any additive. No undissolved particles are discernible.

FIG. 2 shows the photograph of a standard dope which contains 5% by weight (based on pulp) of a chitosonium polymer according to Example 5. Also in this photograph, only enclosed air bubbles but no undissolved particles are visible.

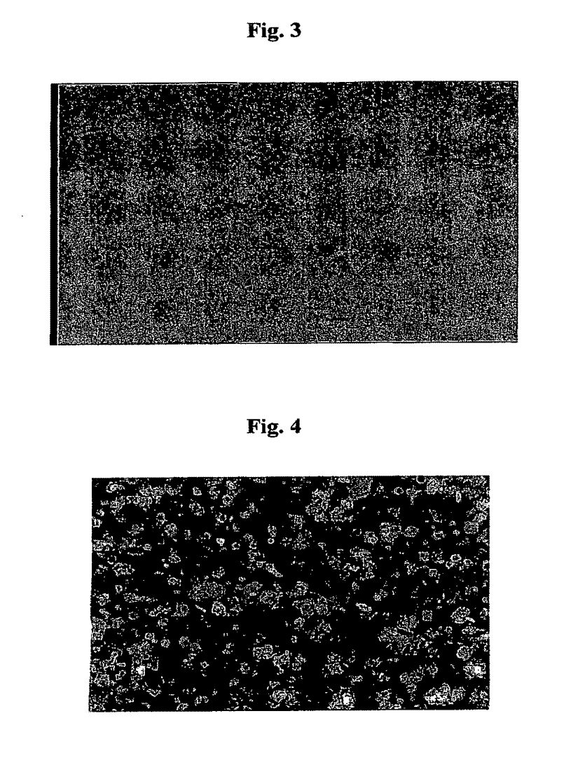

FIG. 3 shows the photograph of a standard dope which contains 10% by weight (based on pulp) of a chitosonium polymer according to Example 1. Small gel-like particles of the chitosonium polymer are visible. For the purpose of the present invention, such particles are regarded as dissolved particles.

FIG. 4 shows the photograph of a standard dope which contains 20% by weight (based on pulp) of an undissolved additive. The undissolved particles of the additive which are not gel-like are clearly visible.

Determination of the Water Retention Value (WRV) of the Fibres

The water retention value is defined as the moisture absorption of a certain amount of fibres due to swelling, expressed in percent of the dry weight.

0.5 g of fibres is stuffed into a centrifugal vessel. The centrifugal vessel is filled with deionized water until the liquid leaks out at the bottom and is then refilled up to the brim with deionized water and is allowed to stand for 5 minutes. The centrifugal vessel is sealed with a plug and is placed into a holding vessel for centrifuges in order to be centrifuged.

Subsequently, it is centrifuged for 15 minutes at 3000 rpm by means of a centrifuge (type Universal, Messrs. Hettich). Thereupon, the fibres are put into a weighing glass and are weighed, wherefrom the wet weight M1 is derived. Subsequently, the fibres are dried for 12 hours at 60° C. in the circulating drying cabinet and are weighed in the exsiccator after having cooled down, wherefrom the wet weight M2 is derived.

The water retention value WRV (%) is calculated from (M1−M2)×100/M2.

### Example 1

### Chitosan-Oligosaccharide Chloride

Chitosan-oligosaccharide type 2, Messrs. Primex Lot. No. G000825-4K, was used for the following Examples:

Form: spray-dried powder=chitosan-oligosaccharide chloride

Content of chitosan-oligosaccharide: 70.1%

Humidity 8.4%

Ash 21.6%

Degree of deacetylation 69%

Average molecular weight 2.5 kDa

Degree of polymerisation DP 12.7

N-content 6.2%

### Example 1.1

The cellulose solutions (spinning masses) are prepared as described in the section “Preparation of a standard dope”.

Composition of the spinning mass:

| Solution ingredients % by weight | Spinning mass 1 |
|---|---|
| NMMO | 76.5 |
| Pulp | 13 |
| Stabilizer | 0.1 |
| Water | 10.5 |
| Addition of chitosan | 1% by weight, based on cellulose |

For preparing the fibres, a melt-index device of Messrs. Davenport as common in plastics processing was used for the spinning mass. Said device consists of a heated temperature-controlled cylinder into which the spinning mass is filled. By means of a piston, which, in the original device, is loaded by a piston (in the adapted version that is used, the advance of the piston is effected via a stepping motor), the spinning mass is extruded through the spinneret mounted to the bottom side of the cylinder. The spinning mass was extruded through a 1-hole/100μ spinneret at a spinning temperature of 125° and at an output rate of 0.03 g/hole/min, and the filament was precipitated in a water bath (temperature 23° C., length 20 cm) after passing an air gap of 30 mm. After 15 minutes of rinsing out the remaining quantity of NMMO, the filament is dried at 60° C. in the circulating drying cabinet. Without any difficulties it is possible to spin fibres having a titre of 0.9 dtex.

The following fibres were obtained:

| | Spinning mass 1 |
|---|---|
| | 1% chitosan-oligosaccharide |
| | chloride, based |
| | on cellulose |
| Titre dtex | 1.41 |
| Maximum tensile force cond. cN/tex | 37.8 |
| Elongation at break cond. % | 11.1 |
| Maximum tensile force wet cN/tex | 35.8 |
| Elongation at break wet % | 11.0 |

### Example 1.2

In a stirrer vessel, spinning masses of the following compositions:

76.3% NMMO/10.5% water/13% pulp/0.13% chitosan-oligosaccharide chloride

76.1% NMMO/10.4% water/12.9% pulp/0.39% chitosan-oligosaccharide chloride and

75.4% NMMO/10.3% water/12.8% pulp/1.29% chitosan-oligosaccharide chloride

were produced from 3433 g of 78% NMMO, 455 g of pulp, 0.05% of a stabilizer (based on cellulose) and 1% by weight, 3% by weight or 10% by weight, respectively, of chitosan-oligosaccharide chloride (based on cellulose) by evaporating the excess amount of water.

Each spinning mass was extruded at a temperature of 120° C. and at an output rate of 0.03 g/hole/min through a 589 holes/100μ spinneret, was stretched in an air gap of a length of 15 mm while being blown at by moist air (40% relative air humidity, temperature 26° C., 10 g water/m³ air), and the cellulose was precipitated in an aqueous spinning bath.

After 30 minutes of rinsing out the remaining quantity of NMMO in the filament, it was cut to a staple length of 40 mm and was dried at 60° C. Prior to drying at room temperature, a portion of the cut fibres is treated for 15 minutes with a solution containing 20 g/l of soda, liquor ratio 1:20, is washed neutrally and then dried at 60° C.

The following fibres were obtained:

| | Spinning mass 2 | Spinning mass 3 | Spinning mass 4 |
|---|---|---|---|
| | 1% chitosan- | 3% chitosan- | 10% chitosan- |
| | oligosaccharide, based | oligosaccharide, based | oligosaccharide, based |
| | on cellulose | on cellulose | on cellulose |
| Titre dtex | 1.61 | 1.7 | 1.65 |
| Maximum tensile | 38.8 | 38.4 | 34.4 |
| force cond. cN/tex | | | |
| Elongation at break | 11.9 | 10.6 | 9.5 |
| cond. % | | | |
| Maximum tensile | 34.2 | 34 | 28.2 |
| force wet cN/tex | | | |
| Elongation at break | 15.8 | 14.4 | 12.1 |
| wet % | | | |
| BISFA wet modulus | 10.4 | 11.9 | 11.1 |
| Loop strength cN/tex | 22.2 | 21 | 15 |
| Loop elongation % | 5 | 5 | 4 |
| N-content % | 0.06 | 0.17 | 0.54 |
| WRV (%) without | 61 | 66 | 67 |
| soda treatment | | | |

In comparison with the standard Lyocell fibre, these fibres exhibit a substantially increased colourability such as illustrated in the following:

Dyeing Test:

0.5 g of dry fibres is dyed for one hour at 80. degree. C. at a liquor ratio of 1:20 with 0.5% (based on cellulose) of Lanaset Marine R, is washed, dried and carded. The samples are measured against the white standard by means of a Cielab colour measuring instrument.

| Sample | L* | a* | B* |
|---|---|---|---|
| Standard Lyocell | 75.51 | −5.15 | −12.25 |
| 1% chitosan, based on | 49.95 | −1.70 | −15.48 |
| cellulose | | | |

Based on the brightness value L* (white standard L*=100, i.e., the lower L*, the darker the sample), the chitosan fibres exhibit a colourability that is increased by 30%. In pure optical terms, that difference is clearly recognizable already with the naked eye, the Lyocell standard sample is dyed sky-blue, the chitosan-incorporated fibres are dyed medium-blue.

### Example 2

### Chitosan Chloride

The chitosan of Messrs. Primex Lot. No. G0111121-1 was used for the following Examples:

Form: spray-dried powder=chitosan chloride

Humidity 12.9%

Ash 4.44%

Degree of deacetylation 55.3%

Average molecular weight 3533 kDa

N-content 6.02%

### Example 2.1

The spinning masses are prepared as described in the section “Preparation of a standard dope”.

Composition of the spinning mass (% by weight): 76.5% NMMO, 13% pulp, 0.1% stabilizer, 1% chitosan chloride, based on cellulose, 10.5% water.

The production of the fibres was carried out as in Example 1.1.

The following fibres were obtained:

| | Spinning mass 5 | Spinning mass 6 |
|---|---|---|
| | 1% chitosan chloride | 5% chitosan chloride |
| Titre dtex | 1.28 | 1.25 |
| Maximum tensile force | 40.8 | 36.7 |
| cond. cN/tex | | |
| Elongation at break | 10.5 | 9.4 |
| cond. % | | |

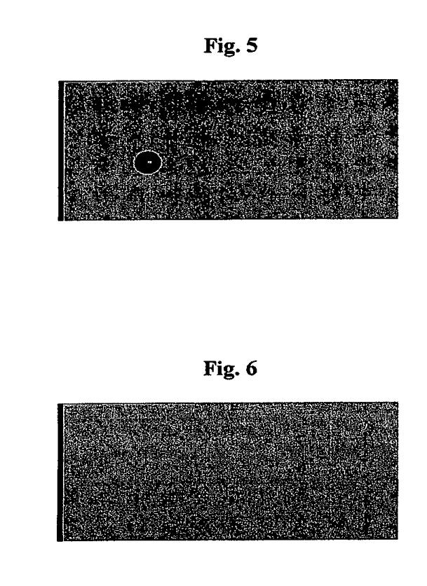

FIG. 5 shows the microphotograph of spinning mass 6. No undissolved particles are detectable.

### Example 2.2

As described in Example 1.2, Lyocell fibres comprising 2% chitosan chloride, based on cellulose, were produced:

### Example 2.2

| | Spinning mass 7 |
|---|---|
| | 2% chitosan chloride, |
| | based on cellulose |
| Titre dtex | 1.51 |
| Maximum tensile force cond. cN/tex | 38.7 |
| Elongation at break cond. % | 12.6 |
| Maximum tensile force wet cN/tex | 35.0 |
| Elongation at break wet % | 16.4 |
| BISFA wet modulus | 10.9 |
| Loop strength cN/tex | 21.2 |
| Loop elongation % | 5.1 |
| N-content % | 0.12 |
| WRV (%) | 69 |

### Example 3

### Chitosan Chloride

The chitosan oligomer of Messrs. Primex Lot. No. G020418-1K was used for the following Example:

Form: spray-dried powder=chitosan chloride

Humidity 8.3%

Ash 6%

Degree of deacetylation 40%

Average molecular weight 1.133 kDa

Degree of polymerisation DP 12.7

N-content 6.46%

As described in Example 1.1, Lyocell fibres comprising 5% by weight of chitosan chloride, based on cellulose, were produced:

| | Spinning mass 8 |
|---|---|
| | 5% chitosan chloride, |
| | based on cellulose |
| Titre dtex | 1.31 |
| Maximum tensile force cond. cN/tex | 38.3 |
| Elongation at break cond. % | 11.6 |

FIG. 6 shows the microphotograph of spinning mass 8. No undissolved particles are detectable.

Fluorescent microphotographs were taken of all chitosan-incorporated Lyocell fibres that were produced: In doing so, the chitosan incorporated in the fibre can be rendered visible in all samples.

Method

0.05 g of a fibre sample is mixed with 1 g of a solution of fluorescein-isothiocyanate, which is prepared as follows: A stock solution of 10 mg fluorescein-isothiocyanate in 1 ml ethanol is diluted with an acetic acid/sodium acetate buffer at a ratio of 1:10000. The fibres are mixed with this solution, are treated for 1 hour, are rinsed out 5 times with deionized water and once with ethanol, are dried at 60° C. and are observed under a fluorescence microscope (Messrs. Olympus, BX 51) at 40-fold magnification. The chitosan is identifiable due to its green fluorescent colouring.

### Example 4

### Treatment of the Never-Dried Fibre

Chitosan oligosaccharide chloride type 2, Messrs. Primex Lot. No. G000825-4K, N-content 6.183%, was used for the following Examples:

At first, solutions of the chitosan oligosaccharide chloride in water (content of chitosan oligosaccharide chloride 1, 2 or 3% by weight, respectively) were prepared and were adjusted to a pH value of 5.70 by adding 10% acetic acid.

At room temperature, 10 g of never-dried Lyocell fibres having a titre of 1.3 dtex is impregnated with the chitosan oligosaccharide chloride solution for 5 minutes at a liquor ratio of 1:20 and is then squeezed at 1 bar. In order to fix the chitosan, the fibre sample subsequently either
is steamed and rinsed out at 100° C. for 5 minutes, or
is alkali-treated (liquor ratio 1:20, 15 minutes at room temperature, 20 g/l of soda) and rinsed out, or
is steamed, alkali-treated and rinsed out.

The test results are summarized in the following table:

| | Chitosan | | | | |
|---|---|---|---|---|---|
| | oligosaccharide | | | | chitosan |
| | chloride solution | Steaming | Soda | N | in fibre |
| Test | (% by weight) | (min.) | (g/l) | (%) | (%) |
| Blank value | — | — | — | 0.019 | — |
| (untreated | | | | | |
| Lyocell fibre) | | | | | |
| 4.1 | 1 | — | — | 0.041 | 0.36 |
| 4.2 | 1 | — | 20 | 0.056 | 0.60 |
| 4.3 | 1 | 5 | — | 0.083 | 1.04 |
| 4.4 | 1 | 5 | 20 | 0.071 | 0.84 |
| 4.5 | 2 | — | — | 0.064 | 0.73 |
| 4.6 | 2 | — | 20 | 0.077 | 0.94 |
| 4.7 | 2 | 5 | — | 0.109 | 1.46 |
| 4.8 | 2 | 5 | 20 | 0.138 | 1.92 |
| 4.9 | 3 | — | — | 0.091 | 1.16 |
| 4.10 | 3 | — | 20 | 0.135 | 1.88 |
| 4.11 | 3 | 5 | — | 0.120 | 1.63 |
| 4.12 | 3 | 5 | 20 | 0.171 | 2.46 |

Several fibre data of the produced fibres are summarized in the following table:

| | | Fibre strenght | Fibre elongation |
|---|---|---|---|
| Test | Titre (dtex) | conditioned (cN/tex) | conditioned (%) |
| Blank value | 1.32 | 27.71 | 12.86 |
| 4.9 | 1.41 | 31.34 | 13.36 |
| 4.10 | 1.37 | 30.61 | 14.55 |
| 4.11 | 1.34 | 30.08 | 13.38 |
| 4.12 | 1.35 | 29.77 | 13.94 |

### Example 5

Chitosan oligomer type 2, Messrs. Primex Lot. No. G020304-2K, was used for the following Examples:

Form: spray-dried powder=chitosan chloride

Humidity 10%

Ash 0.72%

Degree of deacetylation 77%

Average molecular weight 4.06 kDa

N-content 7.03%

At first, solutions of the chitosan oligosaccharide chloride in water (3% by weight) were prepared. The pH value of the solutions amounted to 4.6.

At room temperature, 10 g of never-dried Lyocell fibres having a titre of 1.3 dtex is impregnated with the chitosan oligosaccharide chloride solution for 5 minutes at a liquor ratio of 1:10 and is then squeezed at 1 bar. In order to fix the chitosan, the fibre sample subsequently is either steamed or alkali-treated in analogy to Example 4.

The test results are summarized in the following table:

| | Chitosan | | | | |
|---|---|---|---|---|---|
| | oligosaccharide | | | | Chitosan |
| | chloride solution | Steaming | Soda | N | in fibre |
| Test | (% by weight) | (min.) | (g/l) | (%) | (%) |
| Blamk value | — | — | — | 0.019 | — |
| (untreated | | | | | |
| Lyocell fibre) | | | | | |
| 5.1 | 3 | 5 | — | 0.097 | 1.07 |
| 5.2 | 3 | — | 20 | 0.184 | 2.35 |

Several fibre data of the produced fibres are summarized in the following table:

| | | Fibre strength | Fibre elongation |
|---|---|---|---|
| Test | Titre (dtex) | conditioned (cN/tex) | conditioned (%) |
| Blank value | 1.32 | 27.71 | 12.86 |
| 5.1 | 1.33 | 31.07 | 10.78 |
| 5.2 | 1.4 | 27.98 | 12.62 |

### Example 6

### Treatment with a Cross-Linking Agent

A never-dried Lyocell fibre was impregnated with a chitosan oligosaccharide chloride solution and squeezed at 1 bar such as described in Example 5.

At room temperature, the fibres were subsequently impregnated for 3 minutes with a solution containing 20 g/l of sodium salt of 2,4-dichloro-6-hydroxy-1.3.5-triazine (NHDT) and 16 g/l of NaOH at a liquor ratio of 1:20. Following the impregnation, the fibres were squeezed at 3 bar, were heat-treated with water vapour at 100° C. for 5 minutes, were washed neutrally and dried.

Without any treatment with the cross-linking agent, the fibre impregnated with the chitosan oligosaccharide chloride solution exhibits a content of 2.15% chitosan within the fibre and a wet abrasion value of 60. The wet abrasion value is determined in accordance with the process described, f.i., in WO 99/19555.

The fibre treated both with the chitosan oligosaccharide chloride solution and with NHDT exhibits a wet abrasion value of 499.

We claim:

1. A process for producing cellulosic molded bodies according to an amine oxide process comprising
molding a solution of cellulose in an aqueous tertiary amine oxide,
precipitating the molded solution to obtain a molded body,
washing the molded body,
treating the molded body with a chitosonium polymer and drying the molded body,
wherein the molded body is treated with the chitosonium polymer prior to drying, and wherein the chitosonium polymer has a molecular weight of from 1 to 1500 kDa and is essentially completely soluble in a standard dope solution of cellulose in an aqueous tertiary amine oxide.

2. The process of claim 1, wherein the chitosonium polymer is comprised in a treatment solution in an amount ranging from 0.1% by weight to 10% by weight.

3. The process of claim 1, wherein the chitosonium polymer is comprised in a treatment solution in an amount ranging from 0.5% by weight to 3% by weight.

4. The process of claim 1, wherein the chitosonium polymer is in a solution or suspension form.

5. The process of claim 4, wherein the solution or suspension contains chitosonium polymer in an amount ranging from 0.1% to 10% by weight.

6. The process of claim 4, wherein the solution or suspension contains chitosonium polymer in an amount ranging from 0.5% to 3% by weight.

7. The process of claim 1, further comprising subjecting the molded body to an alkali treatment prior to or after drying.

8. The process of claim 1, further comprising subjecting the molded body to superheated steam prior to or after drying.

9. The process of claim 1, further comprising subjecting the molded body to a crosslinking agent prior to or after drying.

10. The process of claim 1, wherein the chitosonium polymer is selected from the group consisting of chitosonium acetate, chitosonium chloride, chitosonium citrate and chitosonium lactate.

11. The process of claim 1, wherein the molded body is in the form of fibers.
